(19) United States
(12) Patent Application Publication
(10) Pub. No.: US 2024/0354159 A1
(43) Pub. Date: Oct. 24, 2024

(54) DYNAMIC RESOURCE ALLOCATION FOR MANUFACTURING DATA PROCESSING

(71) Applicant: Accenture Global Solutions Limited, Dublin (IE)

(72) Inventors: TRILOK RANGAN, Chalakudy (IN); Rubin George Chacko, Pune (IN)

(21) Appl. No.: 18/303,146

(22) Filed: Apr. 19, 2023

(51) Int. Cl. G06F 9/50; G06Q 50/04

(52) U.S. Cl. CPC G06F 9/5005; G06Q 50/04

(57) ABSTRACT

Methods, systems, and apparatus, including computer programs encoded on computer-storage media, for dynamically allocating computing resources for processing data. In some implementations, a method includes obtaining, over a network, data from one or more units associated with a manufacturing plant indicating addition of a new process or asset to the manufacturing plant; determining an amount of processing resources for performing one or more calculations; generating one or more signals configured to commission the amount of processing resources as a combination of resources from (i) processing resources associated with a cloud-computing system and (ii) processing resources located at a site of the manufacturing plant; processing, by the combination of resources, the data obtained from the one or more units associated with the manufacturing plant to generate one or more performance indicators associated with the manufacturing plant; and providing, to a user device, the one or more performance indicators.

### FIELD

This specification generally relates to dynamically allocating computing resources for processing data, particularly data from industrial manufacturing plants.

### BACKGROUND

Manufacturing plants, or other systems, perform processes using one or more assets. Processes or assets can be monitored using one or more sensors that obtain data for calculations. Adding or removing processes or assets can, correspondingly, increase or decrease computing resources required to generate one or more calculated results for the processes or assets.

### SUMMARY

Techniques described in this document include methods, systems, and apparatuses for dynamically allocating resources for processing data obtained from a manufacturing plant. This can be done, for example, by obtaining data indicative of the operation statuses of assets (such as elements used to manufacture products) or processes (such as actions taken by assets to generate a final or intermediate product) and processing the obtained data within a digital twin representation of the manufacturing plant to determine if the assets and processes are working in accordance with the expected performance indicators.

In a manufacturing plant scenario, many different assets and processes can run simultaneously or in series to generate final products. To operate effectively and to meet various requirements for a final product, the assets and processes can operate according to specified operating conditions that may be evaluated by checking whether one or more performance indicators are satisfying corresponding threshold conditions. In some cases, in order to meet the operating conditions and workload, certain assets may be added to (or removed from) the manufacturing plant and/or modified/new processes may be implemented. In such cases, it is challenging to add corresponding representations of the assets/processes in the digital twin representation of the manufacturing plant without affecting the operation of the plant. The techniques described in this document can allow automatic attachment (or removal) of an asset or process dynamically to the digital twin representation, and/or modify corresponding metrics (or introduce new ones) to calculate performance indicators for the added assets/processes. This is done in a scalable way that does not require stopping/altering workflow in the manufacturing plant or changing the underlying codebase of the digital twin.

Further, techniques described in this document can automatically allocate computing resources, for example, to reduce use of expensive cloud computing resources and/or optimize computing performed on site. For example, computations can be allocated between remote cloud computing systems and on-premises resources in accordance with workload, while utilizing on-premises resources optimally to meet a target performance indicator associated with the computations.

Advantageous implementations can include one or more of the following features. For example, techniques described can reduce an amount of processing power required for a central processing device, such as a network processor communicably connected to one or more on site devices, referred to herein as edge processors. Such network processors can be referred to as a cloud computing device and can include one or more physical processors configured to process data. By allocating computing resources across cloud and edge processors, a control unit can reduce the amount of processing bandwidth required by either cloud or edge processors.

In some implementations, a control unit increases processing efficiency by allocating one or more processing tasks to edge processors that process data in parallel. In some implementations, a control unit decreases processing failures by dynamically starting up and turning off processing devices to process one or more new assets or processes. For example, by dynamically starting up and turning off processing devices, a control unit can prevent processing failures caused by insufficient processing bandwidth or resources available. Such failures can cause production malfunctions when assets or processes do not have sufficient calculated values to, e.g., inform feedback loops for adjusting of assets during production.

In some implementations, techniques described enable dynamic changes to, e.g., manufacturing data processing. For example, manufacturing data can be generated by one or more manufacturing production lines one or more production sites. In some traditional systems, changes to incorporate additional data processing steps, such as new metrics to be calculated or modifications to existing metric calculations (e.g., a production machine's, also referred to as an asset's, utilization), required changes to a codebase. Techniques described in this document allow for the automatic scaling of processing resources to handle new or modified metric calculations, among other data processing changes, without time consuming modifications to an underlying codebase.

One innovative aspect of the subject matter described in this specification is embodied in a method that includes obtaining, over a network, data from one or more units associated with a manufacturing plant, the data indicating addition of a new process or asset to the manufacturing plant; determining one or more calculations to be performed for the new process or asset; determining an amount of processing resources for performing the one or more calculations; generating one or more signals configured to commission the amount of processing resources as a combination of resources from (i) processing resources associated with a cloud-computing system and (ii) processing resources located at a site of the manufacturing plant; processing, by the combination of resources, the data obtained from the one or more units associated with the manufacturing plant to generate one or more performance indicators associated with the manufacturing plant; and providing, to a user device, the one or more performance indicators.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, obtaining data from the one or more units associated with the manufacturing plant over the network includes: obtaining data from one or more computers communicably connected to manufacturing devices at the manufacturing plant. In some implementations, determining the one or more calculations to be performed for the new process or asset includes: parsing a configuration file that includes one or more metrics to be calculated for the new process or asset.

In some implementations, actions include: updating a digital twin model representing the manufacturing plant to include the new process or asset. In some implementations, determining the amount of processing resources for performing the one or more calculations includes: generating one or more values representing an amount of sub-calculations to perform per calculation and an amount of data to process for the one or more calculations; and determining the amount of processing resources for performing the one or more calculations using the one or more values representing the amount of sub-calculations to perform per calculation and the amount of data to process for the one or more calculations.

In some implementations, generating the one or more signals configured to commission (i) the processing resources associated with the cloud-computing system and (ii) the processing resources located at the site of the manufacturing plant includes: generating a signal configured to turn on a processing component of the processing resources associated with the cloud-computing system or the processing resources located at the site of the manufacturing plant.

In some implementations, actions include: obtaining, over the network, data generated by the combination of resources encoded in signals transmitted by the combination of resources, where the data includes the one or more performance indicators. In some implementations, actions include: providing a portion of the data from the one or more units associated with the manufacturing plant to the processing resources associated with the cloud-computing system.

In some implementations, providing, to the user device, the one or more performance indicators includes: generating a signal encoded with data generated by the combination of resources; and providing the signal to a transmitting antenna. In some implementations, actions include: after obtaining the data indicating addition of the new process or asset to the manufacturing plant: obtaining incoming values from the new process or asset during operation at the manufacturing plant; and providing the incoming values to temporary cache storage. In some implementations, the data from the one or more units associated with the manufacturing plant include the incoming values from the new process or asset.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for dynamically allocating computing resources for processing data.

FIG. 2 is a diagram illustrating a mapping of processes, metric calculations, assets, and control engines for allocating computing resources.

FIG. 3 is a flow diagram illustrating an example of a process for dynamically allocating computing resources for processing data.

FIG. 4 is a diagram illustrating an example of a computing system used for dynamically allocating computing resources for processing data.

Like reference numbers and designations in the various drawings indicate like elements.

### DETAILED DESCRIPTION

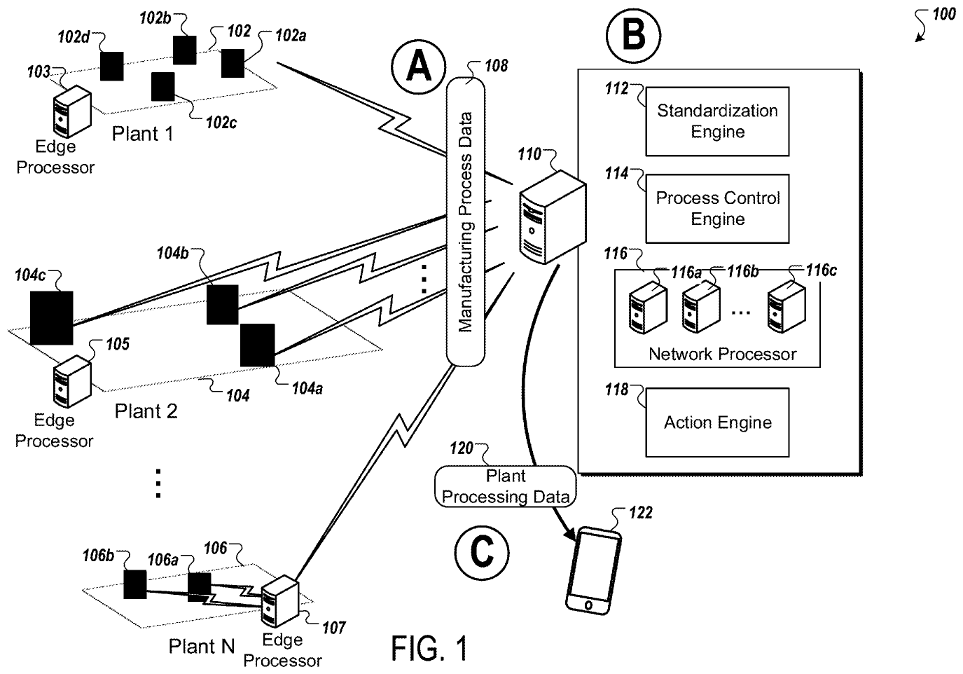

FIG. 1 is a diagram showing an example of a system 100 for dynamically allocating computing resources for processing data. The system 100 includes the three manufacturing plants-plant 1 102, plant 2 104, and plant N 106—control unit 110, and edge processors 103, 105, and 107. The control unit 110 obtains data, such as the manufacturing process data 108, from the manufacturing plants. The control unit 110 dynamically allocates computing resources between, e.g., a network processor 116 and one or more edge processors located at the manufacturing plants—edge processors 103, 105, and 107. The network processor 116 can include one or more sub-computing elements 116a-c to enable parallel computing or increased processing bandwidth.

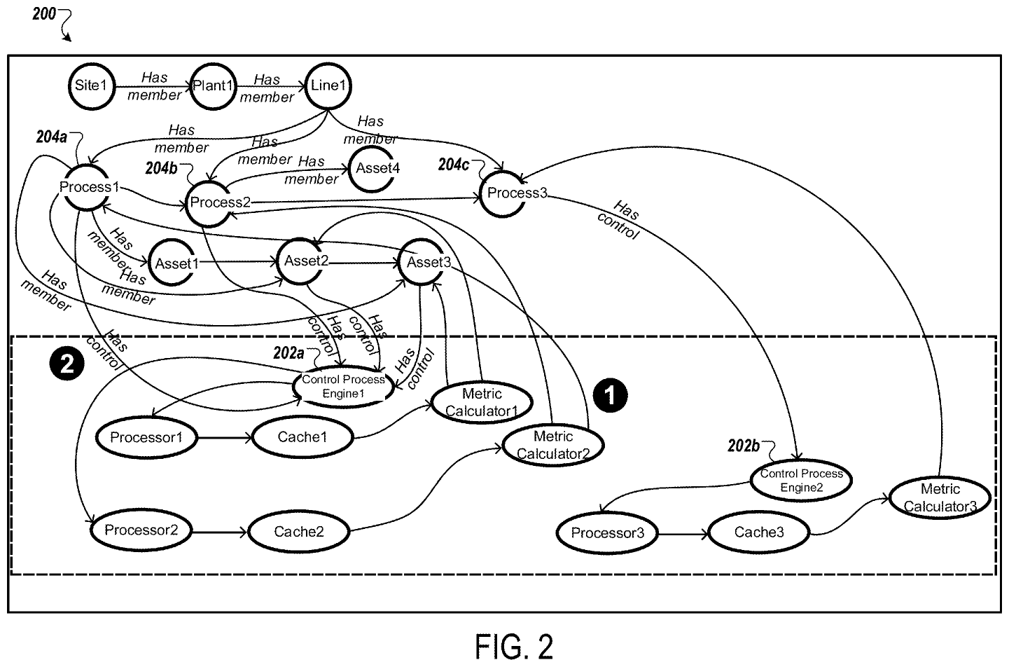

The manufacturing plants 102, 104, and 106 can manufacture any type of products, e.g., components for medical equipment, car parts, among others. Manufactured products typically include different components that are produced by one or more different assets, such as a hydraulic press machine, oven, cutting tool, among others. Each asset can be associated with one or more processes in manufacturing. An example of a relationship of assets, processes, and associated metrics is shown in FIG. 2.

Assets at plant 1 102 include assets 102a-d. Assets at plant 2 104 include assets 104a-c. Assets at plant N 106 include assets 106a-b. The number of plants and assets are shown for illustration purposes. In general, any number of plants, assets, or processes performed using the assets, can be included in the system 100.

FIG. 1 is described with reference to stages A through C. Although described in order from stage A through C, operations of the system 100 can occur in different orders or in parallel. For example, the control unit 110 can obtain one or more elements of manufacturing process data 108, corresponding to stage A, while, before, or after, processing one or more elements of data in stage B. Similarly, operations corresponding to stage C can be performed before one or more data items are obtained or processed by the control unit 110.

In stage A, the control unit 110 obtains manufacturing process data 108. In some implementations, the manufacturing process data 108 includes data indicating one or more new processes or assets, or adjustments to existing processes or assets. For example, the manufacturing process data 108 can include data indicating asset 104a of plant 2 104 is being added. The asset 104a may be brand new hardware recently installed at plant 2 104, repaired hardware coming back online, or an asset taking on a new role, such as performing a different or additional process.

In some implementations, the frequency of data obtained from various systems of the plants 102, 104, and 106 are the same, e.g., every minute, hour, among others. In some implementations, data packets sizes or data schema of each of two or more systems located at one of the plants 102, 104, or 106 are different. The time series data in two or more systems can be co-related. For example, a first system located at the plant 102 can provide equipment information, a second system located at the plant 102 can provide sensor Information for sensors at the plant 102, and a third system located at the plant 102 can provide primitive calculations of sensor and equipment information from the third system.

In an example, the second system can output high fidelity sensor information at a frequency of 1 second while the third system outputs low fidelity calculated information from the first system and the third system at a frequency of every 30 minutes. The first system outputs Overall Equipment Effectiveness (OEE) information of medium fidelity at a frequency of every 1 minute. The control unit 110 can obtain the manufacturing process data 108 and help ensure that calculations given by the third system match raw data from other systems, e.g., the first and third systems.

In general, generating calculated values requires computing resources to obtain and process raw or filtered data from a given manufacturing plant. The required bandwidth or processing power of the computing resources can fluctuate based, at least, on the amount of values to be calculated, the amount of data for each calculation, and the frequency with which to perform the calculation.

In some implementations, the control unit 110 uses real-time time series co-related data flowing in with different fidelity or different frequencies. To determine a relation between data and to calculate key performance indicators (KPIs) over different streams can be a challenging problem to solve. A major problem is that the third system in the present example cannot calculate using data that was previously obtained that was not marked or standardized for longer term storage and later calculation. At any given point, values of the third system may not match the values received from the first and second systems.

The control unit 110 and the system 100 shown in FIG. 1 can solve at least this issue. The control unit 110 can store real-time information from different sources into a memory database. Cache can be updated, e.g., by the control unit 110 and data can be stored as a key value pair, where the key can include a time of the streaming data, e.g., cache date time, and value can include content.

In stage B, the control unit 110 processes the manufacturing process data 108. In some implementations, the control unit 110 processes the manufacturing process data 108 using a standardization engine 112. Operations of the standardization engine 112 can be performed by one or more processors communicably connected to the control unit 110. In some implementations, the standardization engine 112 performs standardization using one or more digital twin models. For example, the standardization engine 112 can obtain one or more digital twin models corresponding to one or more of the plants 102, 104, and 106. Standardization performed by the standardization engine 112 can include adjusting timestamps of data in the manufacturing process data 108, renaming items of the manufacturing process data 108, adding one or more identifiers for elements of the manufacturing process data 108, among others. In general, the standardization engine 112 can generate a standardized version of the manufacturing process data 108 that includes indications that data from related assets, e.g., assets generating components of a product on a production line, are before or after one another and other correlations between elements of the manufacturing process data 108.

In some implementations, the control unit 110 is a digital twin aware dynamic contextual logic engine or DT-CLE. In some implementations, the systems described in this document, such as the system 100, are dynamically tied to a digital twin hierarchy, such as a digital twin hierarchy of an industrial Internet of things (IoT) system, e.g., corresponding to one or more of the plants 102, 104, or 106. The system 100 can solve problems of correlating a complex aggregated as well as discrete hierarchies of assets, such as manufacturing elements, in an industrial manufacturing plant. In traditional systems, adding or modifying an asset, process, or corresponding workloads can involve completely stopping a corresponding asset, process, or corresponding workloads. New versions can be deployed in order to enable changes, e.g., in the asset, process, or corresponding workloads, among others.

This documents provides a dynamic system to handle this problem, e.g., by automatically attaching an asset or process dynamically to a node computing resource, e.g., either network or edge based, representing a workload, such as nodes in a digital model of a manufacturing plant. A dynamic system, such as the system 100 described in this document, can modify or onboard new metrics to a node to, for example, calculate a utilization value of an asset. Utilization values can include downtime, uptime, processing bandwidth, among others.

In some implementations, the control unit 110 performs one or more operations corresponding to the process control engine 114. The process control engine 114 can adjust one or more computing resources to dynamically allocate compute resources in response to adding or removing processing tasks, e.g., for a set of one or more assets or processes.

In some implementations, container technology is used to provide some control on the way workloads are managed and spawned. However, container technology may not be able to dynamically attach systems, processes, or assets in real time. For example, changes to a workload may require a change in a corresponding codebase or a new deployment. Techniques described can improve on a purely container-based solution by allowing for dynamically attaching systems, processes, or assets in real time.

In some implementations, the control unit 110 allocated computing tasks to resources that generate manufacturing based key performance indicators (KPIs). The resources can include edge processors 103, 105, and 107, and network processor 116. The resources can split, categorize, store, and compute data, such as data from one or more manufacturing plants. In some implementations, the control unit optimizes infrastructure (e.g., infrastructure can include underlying systems or structures that support operation of a manufacturing facility including physical structures such as buildings and equipment or digital systems such as software and networks), generates new workloads for processing data, scales up or down processing bandwidth or power for existing workloads, e.g., based on configurations and auto adjustments. The control unit 110 can run compute nodes based on initial settings and subsequent data obtained from one or more sensors or data generating devices, e.g., at a manufacturing plant. The data can be included in the manufacturing process data 108. The control unit 110 can be configured to work on cloud computing resources, such as computing resources communicably connected to one or more devices of a manufacturing plant (e.g., the network processor 116), or on edge computing resources, such as computing resources located at a manufacturing plant (e.g., edge processors 103, 105, and 107).

In some implementations, the control unit 110 generates a workload for processing a specific KPI, such as a manufacturing KPI. The workload can be processed by one or more computing resources, such as the network processor 116 or the edge processors 103, 105, or 107. Workloads can be processed by one or more virtual machines, allocated processing bandwidth on one or more processing devices, among others. Generating a workload by the control unit 110 can be triggered based on a detected event. Detected events can include whenever a threshold is breached, an anomaly is detected, among others. Generating a workload by the control unit 110 can be triggered based on a schedule. The schedule can be predetermined or determined by the control unit 110. The schedule can indicate time increments at which to start or stop generating or adjusting one or more workloads, e.g., hourly, daily, shift-wise, among others.

In some implementations, the control unit 110 operates the process control engine 114. The process control engine 114 can store information that is used for a calculation workload performed by one or more computing resources. The process control engine 114 can determine how much data storage is required for a given calculation workload. The process control engine 114 can determine when to trigger a calculation, when to obtain data and from where, corresponding frequencies for data obtaining or calculation, among others.

In some implementations, a manufacturing cycle is defined by one or more process parameters or machine thresholds. For a given calculation, one or more fields, e.g., indicating one or more process parameters or machine thresholds, may not be required. A given calculation, such as a calculation of a KPI, may only require a subset of the one or more process parameters or machine thresholds.

In some implementations, the process control engine 114 determines one or more fields for each calculation to be used in the calculation to generate a result, such as a KPI for a given process or asset of a manufacturing plant. The process control engine 114 can determine a trigger frequency with which to perform calculations. The process control engine 114 can configure one or more workloads to calculate values based on obtained data every x seconds, hours, days, or other unit of time. In some implementations, the process control engine 114 determines a frequency of calculation to decrease calculations that are computing resource intensive and increase calculations that are not computing resource intensive. In some implementations, the process control engine 114 or the control unit 110 obtains data for generating one or more KPIs or other generated values. The process control engine 114 can parse the data and generate smaller blocks of data for processing. The smaller blocks can be adjustable programmable segments of x-second, hour, day, among others, intervals. Calculation can be performed by aggregating one or more segments of data to form a window duration for analysis.

In some implementations, raw streaming data, such as the manufacturing process data 108 is grouped (e.g., by the control unit 110), sorted, made distinct, or held in memory for a period of time, such as y days, where granularity can be defined in seconds or other time unit. Processed information can be stored, e.g., by the control unit 110, to cache in data units corresponding to the one or more segments, e.g., x-second intervals. In some implementations, multiples of x-second intervals combined form y days of stored information.

In some implementations, calculations use data that is generated, e.g., by an asset or process of a manufacturing plant, at different frequencies. The different frequencies can be different from a calculation workload frequency. F1 can represent the frequency at which a source, such as a process or asset at the manufacturing plant 102, outputs data to be used for one or more calculations.

In some implementations, data generated from one or more data sources, such as a process or asset, is sampled at a sampling rate. This sampling rate can be referred to as F2. Cloud sampling frequency (referred to as Fc) can be used to determine the data collection frequency F2 to auto collect, optimize, or push data to cache or other storage. In some implementations, F2 is defined as F1 multiplied by Fc. If cloud sampling frequency (Fc) is 1/10^{th} of F1, Frequency F2 may be 10 times lower than F1 based on the previous expression. In some implementations, F2 is generated using other expressions. F2 can be dependent on rules or other requirements. The characteristics of F1 can be maintained in F2 even with down sampling.

In some implementations, a breadth of calculations includes parameters which will arrive at different frequencies and will be different from the workload calculation polling frequency. Calculations can use the last one-minute average (window width) of a single parameter. The last one-minute average of a single parameter can indicate an average of all values of the single parameter within a one-minute window.

In some implementations, the process control engine 114 determines processing power required for one or more computing resources to process one or more workloads. For example, the process control engine 114 can determine processing power based on one or more required calculation workloads. In some implementations, the process control engine 114 uses a calculation to determine an amount of processing power to allocate to a given processing device. For example, the process control engine 114 can determine a required amount of CPU power for a given set of one or more calculation workloads using an expression, such as: Max Processing Limit of Processing device (Mx) divided by a number of calculation workloads.

The processing power requirement of each computing resource processing one or more workloads can scale to account for greater data needed to be processed, such as a greater calculation width. For example, for calculations over longer period of times, required computing resources may be greater than calculations over shorter periods of time. Similarly, if a given calculation requires a larger number of intermediate calculations, required computing resources may be greater than calculations that require fewer intermediate calculations. Workloads can be defined by a number of unique calculations defined or required by a given system. The number of workloads can be proportional to an amount of required processing power.

In some implementations, unused memory or cache is cleared. For example, the system 100 can determine one or more hardware devices that are not processing data and generate instructions configured to clear memory or cache of the corresponding devices or power off the devices. For example, the process control engine 114 can generate signals to adjust computing resources, such as edge processors 103, 105, and 107, or the network processor 116. Adjusting computing resources can include clearing cache or memory, turning off, turning on, among other actions. In some implementations, the system 100 determines required cache or memory for one or more processes. For example, the system 100 can determine, using data indicating a number of intermediate calculations for a given calculated result or data indicating an amount of data required for given calculated result, an amount of cache or memory required to generate the calculated result using one or more devices implementing a workload. In some implementations, a cache size is given by an expression, such as: (CH1)=αW1+βFt+γF2+ΩW1, where CH1 is an amount of cache, W1 indicates an amount of data to be processed, F2 indicates a data collection frequency, and Ft indicates an amount of intermediate calculations for a given calculated result.

In some implementations, the process control engine 114 of the system 100 auto adjusts storage capacity requirements. For example, the process control engine 114 of the system 100 can auto adjust storage capacity requirements using data indicating a frequency of one or more determined parameters. For example, if W1, F2 and F3 frequencies are low then the storage capacity would be increased as computing resources will be generating and storing more data points. Storage capacity can be set to a default, e.g., 2 times a data volume or less than a minimum average data volume for a set data collection frequency F2.

In some implementations, platform events processed by the system 100 include storage events and processing events. Processing events can exponentially increase or decrease the processing power. Storage events can exponentially increase or decrease the storage capacity. Both processing power and storage capacity can be generated by the process control engine 114 to determine how to allocate workloads to one or more computing resources.

In some implementations, issues with data gathering or sensors on a plant site causes no data to be present for a calculation. The system 100 can resolve data consistency issues of incoming data. Playback of past events can be stored, e.g., playback of past events can be used to determine trends and extrapolate events based on historic data. There may be periods when there are not data points or a calculation fails due to incorrect data points or no data being obtained from one or more of the plants 102, 104, 106. The control unit 110 can handle this by recovery of lost data from a service bus like queue of data that is cleansed, unique, and relevant for a given calculation or workload.

In some implementations, the control unit 110 includes one or more models that are trained to increase or decrease an amount of data history to help prevent issues with data constituency. For example, the control unit 110 can train one or more models to learn from a queue event after every analytical cycle is completed to identify how frequently data is lost (e.g., not obtained from the plants 102, 104, or 106 and causing errors in downstream calculation in one or more computing resources computing one or more workloads) and based on that increase or decrease a retention period of a queue of previously obtained data automatically. This is an open loop queueing retention system. In some implementations, this can correct for data that arrives late due to delays within the system that cause some data to arrive later than other data.

In one example case, the control unit 110 can perform on or more metric calculations and determine whether a calculation was successful or not, whether there are duplicate calculations, bad or missing data and what is the Quality of Service (Q1) of a computing processor used to process a corresponding workload to generate the calculations.

In some implementations, this is derived using a formula. For example, processing power (PP) can be defined as A*No of Metrics to calculate+B*Qp+C*Qm where CH and PP will give infrastructure scaling decision. In some implementations, CH scales faster as 2×,4× and scale down will be ½×, ¼× on cloud while on the Edge it might scale slower, e.g., 1.25×, 1.50×, 1.75×. A scaling rate can take into account scaling capabilities of a given system being scaled, where cloud systems may be able to scale up or scale down at a faster rate compared to standalone systems with limited hardware capabilities, such as edge processors. Processing Power can have similar scale up and scale down like the cache calculations discussed previously in this document. A, B, C in the above example formula can be empirically derived via capacity of a platform and a use case complexity. Qp can represent a quality of data to be processed. Qp can be related to a data collection frequency F2. Down sampling may be prevented if quality is poor, e.g., Qp=f(F1)+f(F2). Qm can represent a quality of calculated data, such as Qm=f(Ft)+f (W1). Processing Time can be represented as F1/F2. Processing time can be a weighted average of Qp, Qm, F1 and F2 as shown in the example table below:

Weighted Average of Processing Time

| | Data Point | Assigned | Data Point |
|---|---|---|---|
| Data Point | Value | Weight | Weighted Value |
| No of Metrics | 5 | 5 | 25 |
| Qm | 25 | 2.5 | 62.5 |
| Qp | 50 | 1.5 | 75 |
| TOTAL | 100 | 9 | 162.5 |
| Weighted Average | | | 18 |

In some implementations, capacity and data processing are inferred. A method of data processing can be determined dynamically based on a weighted average. In some implementations, dynamic determinations can include autoscaling, downscaling using a scaler to auto size the infrastructure based on the processing needs. The control unit can implement the process control engine 114 that implements an intelligent scaler.

The process control engine 114 can be self-adjusting either for capacity, infrastructure and data, or self-recovering via smart recovery using service Bus like queue. The data Loss parameter is dependent of F2, as for high frequency data, minor data loss is acceptable but not acceptable for low frequency data. In some implementations, data quality suffers if there is content lost in data streaming at low frequencies (e.g., infrequently obtained data from one or more data producing systems). Hence there can be a relation between a loss parameter and data streaming frequency, e.g., indicating that lower frequency data corresponds to a lower tolerance or threshold for data loss. Hence these parameters can help derive a capacity and frequency of data.

In some implementations, the process control engine 114 determines which workloads to be created for a given data source. The process control engine 114 can determine which workloads are to be created for a given use case and at what frequency. The process control engine 114 can use information provided in a configuration file to determine whether a workload is to be run on edge or cloud processing components and at what frequency.

In some implementations, the process control engine 114 maps a data schema, such as one or more rules of a problem and a solution that needs to be generated. The process control engine 114 can select an audit rule and apply the selected audit rule to a rules engine. The rules engine can return a value indicating true or false for a given KPI. In some implementations, the process control engine 114 selects a schema from data provided by the control unit 110 and applies the schema with a relevant data source. The process control engine 114 can generate one or more changes to one or more configuration files to generate one or more calculations in one or more use cases.

In some implementations, the process control engine 114 maps a data schema, rules of a problem, and a solution to be applied. For example, the process control engine 114 can select an audit rule and apply the audit rule to a rules engine mapping to action engine 118. The action engine 118 can generate one or more values indicating true or false for a given KPI. In some implementations, a data schema is dynamic. For example, the process control engine 114 can select a schema from one or more provided by the standardization engine 112 and apply the selected schema to a relevant data source. In general, one or more configuration changes in the system 100 can be used to solve a given use case, such as determining KPIs being in range or not in range for one or more manufacturing processes and one or more dynamic actions in response to comparing data source values to one or more thresholds from a schema.

In some implementations, the system 100 uses edge analytics running on one or more edge processors (e.g., edge processors 103, 105, or 107) to determine system behavior and faster decisions for autonomous workloads to and auto-manage and orchestrate actions defined by one or more business rules. For example, the system 100 can use one or more digital twins, e.g., provided by the standardization engine 112, to scale dynamically processing requirements for processing data from one or more manufacturing plants—e.g., increasing or decreasing associated processing requirements by turning on or turning off processing systems, such as computers. Scaling dynamically can include making decisions without direct human intervention on disparate systems. The process control engine 114 can control one or more actions determined by the system 100. The process control engine 114 can control one or more actions remotely from the plants shown in FIG. 1 or on site of one or more plants.

In some implementations, the system 100 uses intelligent edge analytics to determine system behavior and faster decision for autonomous workloads and auto-manage and orchestrate behaviors that are coherent to one or more defined rules for the control unit 110 or the plants 102, 104, and 106. The process control engine 114 can control one or more computing resources in the network processor 116 or the edge processors 103, 105, and 107.

In some implementations, the process control engine 114 operates as a load balancer to allocate computing tasks across one or more computing resources, e.g., the network processor 116 or one or more of the edge processors. In some implementations, the control unit 110 operates on cloud computing. For example, the control unit 110 can operate on one or more computing resources of the network processor 116. In some implementations, the control unit 110 operates on one or more edge processors, such as edge processors 103, 105, or 107. The solution is applicable to both computing at edge, in the cloud, or distributed across.

In some implementations, the control unit 110 performs one or more operations for edge to cloud or cloud to edge synchronization. The control unit 110 can synchronize processing by the network processor 116 and the edge processors 103, 105, and 107. For example, control unit 110 can optimize workloads, e.g., after synchronizing digital twins between one or more nodes. The control unit 110 can patch a Digital Twin, e.g., representing one or more of the plants 102, 104, and 106, to managed version control for all the compute nodes. The control unit 110 can copy, retrieve, backup, retry, or recover a container for a workload operated by one or more computing processors.

In some implementations, patching a digital twin can include updating a digital twin with a workload instance configuration. For example, the workload instance can include newly added, removed or updated workloads. Patching of a digital twin can be performed by the control unit 110. Benefits of having a digital twin for calculation can include having an ability to trigger instant changes to infrastructure—e.g., scaling or descaling of infrastructure such as memory or CPU or turning off or turning on workloads configured to process one or more items of data—based on one or more of: computation required, data required for analytics, network bandwidth, current data volume, or frequency of the data stream.

In stage C, the control unit 110 provides plant processing data 120 to a device 122. The plant processing data 120 can be configured by the control unit 110 to be rendered in a graphical user interface on the device 122. The plant processing data 120 can include an indication of one or more metrics above or below a threshold level. The plant processing data 120 can include data indicating an automated action performed by the control unit 110 in response to processing one or more calculations using the edge processors 103, 105, 107, or the network processor 116. For example, the control unit 110 can process one or more calculations to determine one or more metrics. A metric of the one or more generated metrics can be compared to a threshold. If the control unit 110 determines that a generated metric satisfies a threshold, the control unit 110 can automatically generate and transmit one or more signals. The one or more signals can be configured to power up or power down processing devices, stop operation of an asset (e.g., to prevent damage based on a metric being outside a safety threshold), among others.

FIG. 2 is a diagram illustrating a mapping 200 of processes, metric calculations, assets, and control engines for allocating computing resources. The mapping 200 includes a digital twin graph. The digital twin graph can be used by the system 100, e.g., the control unit 110, to dynamically configure infrastructure (e.g., CPU, memory, workloads, network bandwidth, among others), scale workloads, or generate new workloads. As shown in the mapping 200, an asset and process hierarchy of a production line (e.g., used to produce one or more components of a manufactured product) in a plant of a site can be connected to one or more nodes.

Changes to an asset or process be it adding, deleting, or updating of an asset or process can be handled by a control process engine, such as the process control engine 114 of the system 100. The control process engine can route data indicating changes to an asset or process to a relevant application node to process the request. The mapping 200 includes two instances of control process engines 202a and 202b. The control process engines 202a control data processing corresponding to processes 204a-c that are performed at Plant 1 of Site 1 by, at least in part, assets 1-4. The mapping 200 shows an example set of processes, assets and metric calculators. Other collections or combinations of elements can be used in other implementations.

In one example case, the system 100 may add a new asset to plant 102 and calculate a yield of the new asset. The control unit 110, for example, can generate a new node in an asset hierarchy of a digital twin and connect it to a control process engine. The control process engine can detect an addition of a node representing the new asset and pass this information to a relevant application for the new asset. The relevant application nodes can further route information across different applications until an asset is onboarded, configurations added for that asset and a corresponding workload can be updated to detect the new asset.

The dynamicity can also work if, for example, the system 100 updates one or more operating rules or add a new operating rule to, e.g., additionally calculate an asset utilization for the newly onboarded asset or for one or more or all existing asset nodes. The digital twin of the mapping 200 can include a control process engine (such as engine 202a or 202b) that checks for a process handling this request. The control process engine can route data to a metrics calculator (e.g., MetricCalculator1, MetricCalculator2, or MetricCalculator3 as shown in the mapping 200) associated with each respective asset, add or update a calculation rule, get the calculated value from a workload, or update a corresponding asset node with a new calculation to make the process dynamic and autocorrective. If at any point the control process engine Hasprocess (e.g., a label of a connection between a control process engine and a processor, such as Processor1 or Processor2, not shown in FIG. 2) gets an input that the workloads are running at full capacity, the control process engine, such as the process control engine 114, can trigger scaling of new workloads to balance the load.

The mapping 200 is shown in FIG. 2 with labeled connectors between elements. The labeled connectors, such as the “has member” label from Line1 to Process1 204a represent the data elements of the mapping 200 indicating a parameter of, e.g., the Process1 204a. In the example of FIG. 2, the Process1 204a has three members (e.g., assets 1-3) and feeds to Process2 204b which feeds to Process3 204c which represents the manufacturing at the Plant1—e.g., a product is made by one or more processes performed by one or more assets in a sequence. For ease of illustration, some labels of connections are not included. In general, processing techniques can use the labeled connection data to realize techniques described in this document, e.g., by reading the data or adding additional connections or elements. Processors can be added or removed to represent real world changes to processing equipment, such as turning a processing machine off or on.

The system 100 can be flexible in that, for example, a few months or some time later, if a same KPI is to be calculated for Process1 204a, in addition to some previously calculated KIP for another process, then Step No. 1 and Step No. 2-shown in FIG. 2 corresponding to adding new, specific relationships between a process, a control process engine, and a metric calculator—are added dynamically to start both KPI visualization and calculation. MetricIsAttachedTo label (not shown in FIG. 2) can connect a process control engine with corresponding assets or processes for which metrics are being calculated. The connection label can help ensure that Process1 has a given metric calculated by the Metric Calculator 2, e.g., on a visualization dashboard. Has Control relationship helps to ensure that a workload is started when a relationship is added or when data for a given process or asset starts flowing in the platform.

One or more techniques described in this document can be embodied in the following example pseudo algorithm as follows:

```
Input
  Reference to a twin model table and digital twin (e.g., mapping 200 of FIG. 2)
Step 1: Read data that are base hierarchy (root nodes) of the system
  1.1: Read a base template which provides a base hierarchy (or namespace or mnemonic) of a
system (e.g., Site−>Plant−>Line−>Process/Asset)
  1.2: Read data rows and filter data with column C1 which is model type as “Site”
(BasePlantModel;1) and its column c3 which is namespace (or name) e.g.,
dtmi:OrgShortName:Level1_Site-S1;v1 or Column C5 which is name as S1.
  1.3 Read complete data and fetch all data d1 belongs to site S1 of the organization by filter all
data with column C5 Site as S1
  1.4 Read the data d1 and fetch the row with Column C1 model type as “Plant” and the column C6
parent namespace value as dtmi:OrgShortName:Level1_Site-S1;v1. The resultant data's column C1
namespace value is: dtmi:OrgShortName:Level2_Site-S1_Plant-P1;v1
  1.5 Read the data d1 and fetch the row with Column C1 model type as “Line” and the column C6
parent namespace value as dtmi:dtmi:OrgShortName:Level2_Site-S1_Plant-P1;v1 . The resultant data's
column C1 namespace value is dtmi:OrgShortName:Level2_Site-S1_Plant-P1_Line-L1;v1. The base root
hierarchy can be retrieved now.
Step 2: Read the data and retrieve the sequence of process and asset involved
  2.1: Fetch the data with column C6 parent namespace value as dtmi:OrgShortName:Level2_Site-
S1_Plant-P1_Line-L1;v1 . The resultant returns one record of column 6 value as
dtmi:OrgShortName:Level2_Site-S1_Plant-P1_Line-L1_Process01;v1
Step 3: Access the data and retrieve the sequence of process and asset involved
  2.1: Fetch the data with column C6 parent namespace value as dtmi:OrgShortName:Level2_Site-
S1_Plant-P1_Line-L1;v1 . The resultant returns two records of column 6 value as
dtmi:OrgShortName:Level2_Site-S1_Plant-P1_Line-L1_Process01_Asset01;v1 with column C1 model
type as “Process” and dtmi:OrgShortName:Level2_Site-S1_Plant-P1_Line-L1_Process01_Process02;v1
with column C4 model type as “Process”. The column C4 represent the relationship name between the
parent and child nodes which is “HasMember” and “Feeds” for the “Asset” and “process” model type
respectively.
```

An example of workflow steps can include:
Step 1: New Asset Node Added
Step 2: Asset Event Triggers Update to control process engine
Step 3: Control process engine checks for process handling this asset and accordingly patches the information to the control process engine app and triggers the event to the processor workload for processing the values associated with the new asset.
Step 4: The control process engine app routes this information to cache that triggers a caching workload to temporarily store all incoming values from a new asset before routing information of the new asset to a metrics application.
Step 5: The metrics application node triggers a metrics calculator workload that then calculates KPIs associated with the new Asset.

In a hypothetical use case of a factory manufacturing discrete components for a medical equipment, different components can go into medical equipment. Each component can be produced by different assets and in turn assets are associated with certain processes in manufacturing. This manufacturing can be represented in a complex graphical hierarchy of assets linked to process and process linked to SKUs of different components, e.g., the mapping 200 of FIG. 2.

For example: Process1 204a (e.g., a soldering process) can be associated with Asset 1 (e.g., a soldering machine) and Asset 3 (e.g., an imaging machine). Asset 2 (e.g., a gluing machine) can be associated with Asset 1 (e.g., soldering machine) for gluing a product after soldering. Asset 2 (e.g, gluing machine) can also be associated also with Asset 3 (e.g., imaging machine) to verify if glue is correctly applied. Asset 3 can also be used for validation of the Process1 204a which includes soldering and gluing. Images from machines can be sent to workloads, e.g., by the control unit 110 of FIG. 1, for completing verification and detecting any errors or deltas in the process 1 or utilization of the Assets (1 and 2). This information can be handled by a control process engine node (such as the control process engine 1 202a) that checks a processing power and scaling required to perform the functionality—e.g., of image validation—and will accordingly route data to a corresponding application node and processor.

The control process engine can generate a new workload for processing the imaging information and the utilization information or can scale an existing workload. The control process engine node can route information to a cache node that can trigger a workload to store one or more elements, or all elements, of information processed by a processor workload following a similar scaling or spawning approach discussed in this document. Once a cache routes cache information to a metrics calculator node that can similarly generate or scale a workload to transform a cleansed, transformed information into metrics which would be feedback ultimately to the Asset and Process Nodes in the Digital Twin or provided as the output plant processing data 120 to the device 122.

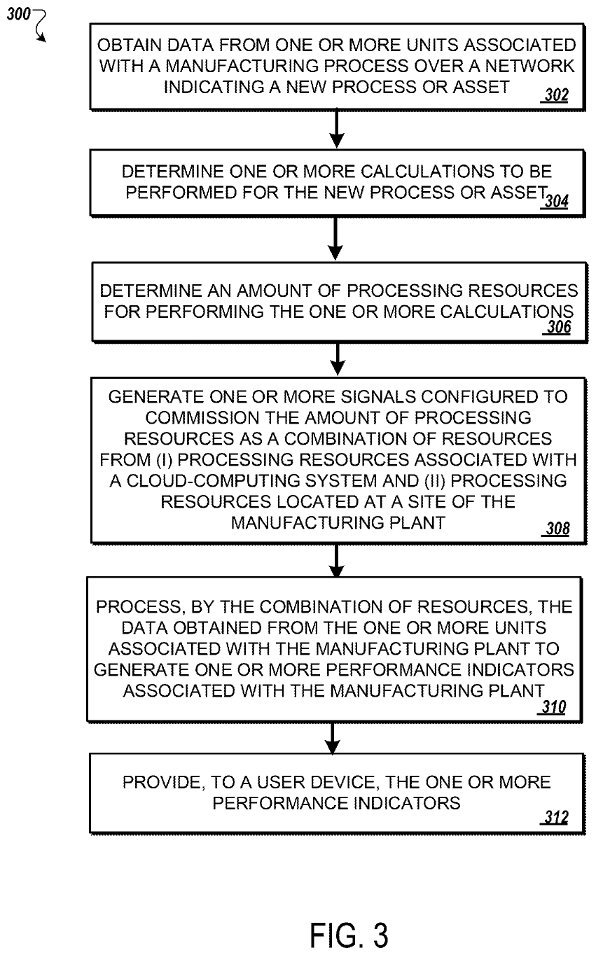

FIG. 3 is a flow diagram illustrating an example of a process for dynamically allocating computing resources for processing data. The process 300 may be performed by one or more electronic systems, for example, the system 100 of FIG. 1.

The process 300 includes obtaining data from one or more units associated with a manufacturing process over a network indicating a new process or asset (302). For example, the control unit 110 can obtain the manufacturing process data from one or more devices at the plants 102, 104, and 106, among others not shown. In general, any number of plants or devices at one or more plants can provide data to the control unit 110.

The process 300 includes determining one or more calculations to be performed for the new process or asset (304). For example, the control unit 110 can determine a new process or asset has been added to one or more of the plants 102, 104, or 106. The control unit 110 can add the new process or asset to a digital twin or mapping 200 as shown in FIG. 2. The control unit 110 can determine one or more metrics to be calculated, such as KPIs, for the new process or asset. The control unit 110 can determine one or more calculations to be performed to generate one or more calculated metrics. The control unit 110 can determine an amount of data that needs to be processed to perform those one or more calculations. Required sub-calculations or data needed for one or more calculations can be included in one or more configuration files for the control unit 110 that can be updated by a user of the control unit 110 or automatically by the control unit 110 itself.

The process 300 includes determining an amount of processing resources for performing the one or more calculations (306). For example, the control unit 110 can generate one or more values using one or more formulas representing an amount of sub-calculations to perform per calculation and an amount of data to process. Using the amount of calculations to perform and an amount of data to process, the control unit 110 can determine an amount of processing resources required for performing the one or more calculations. In some implementations, the control unit determines a frequency of data provided by a system of one or more plants. In general, the control unit 110 can determine calculations that require data from higher frequency systems require more processing resources and calculations that require data from lower frequency systems require less processing resources.

The process 300 includes generating one or more signals configured to commission the amount of resources as a combination of resources from (i) processing resources associated with a cloud-computing system and (ii) processing resources located at a site of the manufacturing plant (308). For example, the control unit 110 can generate a signal configured to adjust the network processor 116 or one or more of the edge processors 103, 105, and 107.

The process 300 includes processing, by the combination of resources, the data obtained from the one or more units associated with the manufacturing plant to generate one or more performance indicators associated with the manufacturing plant (310). For example, the network processor 116 or one or more of the edge processors 103, 105, and 107 can process data, e.g., provided by the control unit 110. The control unit 110 can obtain data generated from the network processor 116 or one or more of the edge processors 103, 105, and 107 processing data from one or more of the systems operating at the plants 102, 104, or 106.

The process 300 includes providing, to a user device, the one or more performance indicators, e.g., obtained data generated by (i) processing resources on a network or (ii) processing resources located at the manufacturing plant that process the data obtained from the manufacturing process (312). For example, the control unit 110 can provide the plant processing data 120 to the device 122. The device 122 can be communicably connected to the control unit 110. The device 122 can be equipped with a screen configured to display the plant processing data 120 for a user of the device 122. The plant processing data 120 can be used to visualize elements of one or more of the plants 102, 104, or 106.

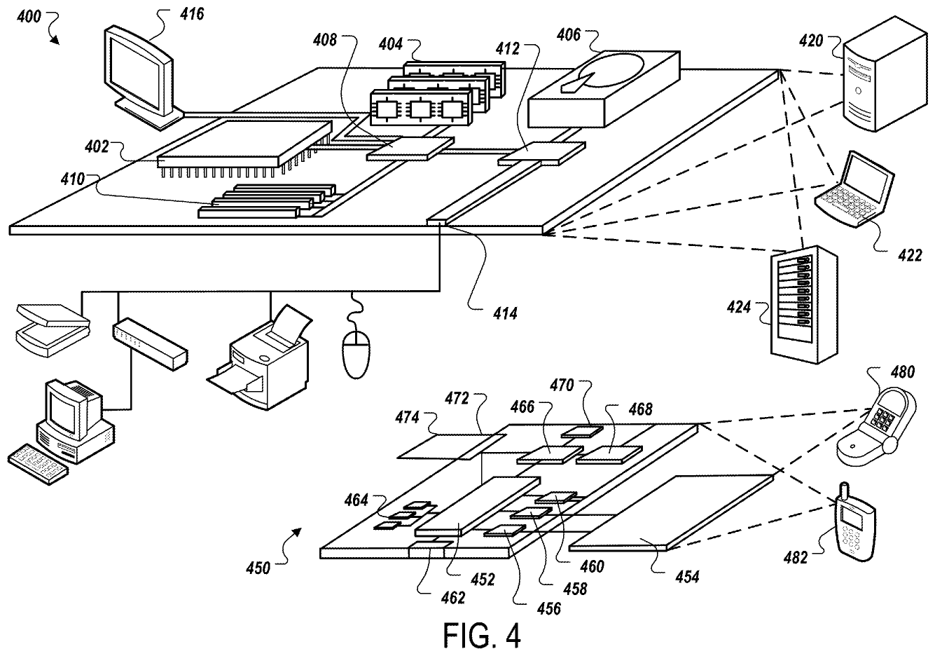

FIG. 4 is a diagram illustrating an example of a computing system used for dynamically allocating computing resources for processing data. The computing system includes computing device 400 and a mobile computing device 450 that can be used to implement the techniques described herein. For example, one or more components of the system 100 could be an example of the computing device 400 or the mobile computing device 450, such as a computer system implementing the control unit 110, devices that access information from the control unit 110, or a server that accesses or stores information regarding the operations performed by the control unit 110.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method for dynamically allocating computing resources for processing data, the method comprising:
obtaining, over a network, data from one or more units associated with a manufacturing plant, the data indicating addition of a new process or asset to the manufacturing plant;
determining one or more calculations to be performed for the new process or asset;
determining an amount of processing resources for performing the one or more calculations;
generating one or more signals configured to commission the amount of processing resources as a combination of resources from (i) processing resources associated with a cloud-computing system and (ii) processing resources located at a site of the manufacturing plant;
processing, by the combination of resources, the data obtained from the one or more units associated with the manufacturing plant to generate one or more performance indicators associated with the manufacturing plant; and
providing, to a user device, the one or more performance indicators.

2. The method of claim 1, wherein obtaining data from the one or more units associated with the manufacturing plant over the network comprises:
obtaining data from one or more computers communicably connected to manufacturing devices at the manufacturing plant.

3. The method of claim 1, wherein determining the one or more calculations to be performed for the new process or asset comprises:
parsing a configuration file that includes one or more metrics to be calculated for the new process or asset.

4. The method of claim 1, comprising:
updating a digital twin model representing the manufacturing plant to include the new process or asset.

5. The method of claim 1, wherein determining the amount of processing resources for performing the one or more calculations comprises:
generating one or more values representing an amount of sub-calculations to perform per calculation and an amount of data to process for the one or more calculations; and
determining the amount of processing resources for performing the one or more calculations using the one or more values representing the amount of sub-calculations to perform per calculation and the amount of data to process for the one or more calculations.

6. The method of claim 1, wherein generating the one or more signals configured to commission (i) the processing resources associated with the cloud-computing system and (ii) the processing resources located at the site of the manufacturing plant comprises:
generating a signal configured to turn on a processing component of the processing resources associated with the cloud-computing system or the processing resources located at the site of the manufacturing plant.

7. The method of claim 1, comprising:
obtaining, over the network, data generated by the combination of resources encoded in signals transmitted by the combination of resources, wherein the data includes the one or more performance indicators.

8. The method of claim 1, comprising:
providing a portion of the data from the one or more units associated with the manufacturing plant to the processing resources associated with the cloud-computing system.

9. The method of claim 1, wherein providing, to the user device, the one or more performance indicators comprises:
generating a signal encoded with data generated by the combination of resources; and
providing the signal to a transmitting antenna.

10. The method of claim 1, comprising:
after obtaining the data indicating addition of the new process or asset to the manufacturing plant:
obtaining incoming values from the new process or asset during operation at the manufacturing plant; and
providing the incoming values to temporary cache storage.

11. The method of claim 10, wherein the data from the one or more units associated with the manufacturing plant include the incoming values from the new process or asset.

12. A non-transitory computer-readable medium storing one or more instructions executable by a computer system to perform operations comprising:
obtaining, over a network, data from one or more units associated with a manufacturing plant, the data indicating addition of a new process or asset to the manufacturing plant;
determining one or more calculations to be performed for the new process or asset;
determining an amount of processing resources for performing the one or more calculations;
generating one or more signals configured to commission the amount of processing resources as a combination of resources from (i) processing resources associated with a cloud-computing system and (ii) processing resources located at a site of the manufacturing plant;
processing, by the combination of resources, the data obtained from the one or more units associated with the manufacturing plant to generate one or more performance indicators associated with the manufacturing plant; and
providing, to a user device, the one or more performance indicators.

13. The medium of claim 12, wherein obtaining data from the one or more units associated with the manufacturing plant over the network comprises:
obtaining data from one or more computers communicably connected to manufacturing devices at the manufacturing plant.

14. The medium of claim 12, wherein determining the one or more calculations to be performed for the new process or asset comprises:
parsing a configuration file that includes one or more metrics to be calculated for the new process or asset.

15. The medium of claim 12, wherein the operations comprise:
updating a digital twin model representing the manufacturing plant to include the new process or asset.

16. The medium of claim 12, wherein determining the amount of processing resources for performing the one or more calculations comprises:
generating one or more values representing an amount of sub-calculations to perform per calculation and an amount of data to process for the one or more calculations; and
determining the amount of processing resources for performing the one or more calculations using the one or more values representing the amount of sub-calculations to perform per calculation and the amount of data to process for the one or more calculations.

17. The medium of claim 12, wherein generating the one or more signals configured to commission (i) the processing resources associated with the cloud-computing system and (ii) the processing resources located at the site of the manufacturing plant comprises:
generating a signal configured to turn on a processing component of the processing resources associated with the cloud-computing system or the processing resources located at the site of the manufacturing plant.

18. The medium of claim 12, wherein the operations comprise:
obtaining, over the network, data generated by the combination of resources encoded in signals transmitted by the combination of resources, wherein the data includes the one or more performance indicators.

19. The medium of claim 12, wherein the operations comprise:
providing a portion of the data from the one or more units associated with the manufacturing plant to the processing resources associated with the cloud-computing system.

20. A system, comprising:
one or more processors; and
machine-readable media interoperably coupled with the one or more processors and storing one or more instructions that, when executed by the one or more processors, perform operations comprising:
obtaining, over a network, data from one or more units associated with a manufacturing plant, the data indicating addition of a new process or asset to the manufacturing plant;
determining one or more calculations to be performed for the new process or asset;
determining an amount of processing resources for performing the one or more calculations;
generating one or more signals configured to commission the amount of processing resources as a combination of resources from (i) processing resources associated with a cloud-computing system and (ii) processing resources located at a site of the manufacturing plant;
processing, by the combination of resources, the data obtained from the one or more units associated with the manufacturing plant to generate one or more performance indicators associated with the manufacturing plant; and
providing, to a user device, the one or more performance indicators.
